(19) United States
(12) Patent Application Publication
(10) Pub. No.: US 2008/0066625 A1
(43) Pub. Date: Mar. 20, 2008

(54) Kettle temperature sensing device

(76) Inventor: Jui-Peng Huang, Taipei County (TW)

Correspondence Address: Jui-Peng Huang, 235 Chung - Ho, Box 8-24, Taipei, omitted

(21) Appl. No.: 11/522,808

(22) Filed: Sep. 18, 2006

(51) Int. Cl. A47J 43/28

(52) U.S. Cl. 99/342

(57) ABSTRACT

A kettle temperature sensing device includes a kettle body capable of being placed upon a heating unit; a periphery of the kettle body having a mouth and a handle; a kettle cover covering upon an opening of the kettle body; a center of the kettle cover being installed with a holding head; and a detector installed on the holding head of the kettle cover; the detector having a temperature sensing element for measuring water temperature; and the detector having a display for displaying values of temperature. The water temperature in the kettle can be measured directly and displayed real time.

### FIELD OF THE INVENTION

The present invention relates kettles, and particularly to a kettle temperature sensing device, which can detect the temperature of water in the kettle and display the temperature real time and thus the user can make tea or coffee with a preferred temperature control.

### BACKGROUND OF THE INVENTION

Conventionally, in making tea or coffee, the water temperature is about 70° C.˜100° C. according to the kinds of the tea or coffee. The destroy to vitamin C is reduced. This is also suitable to make coffee.

Conventionally, the temperature for making tea is determined by experience, but this cannot have a desired temperature. The water is boiled and then cooled to a desired temperature. To have a desired temperature, some people measure the temperature by a thermometer. However, it is inconvenient.

Thus, there is an eager demand for a novel way which can provide temperature value to the users real time so that the user can control the temperature in making tea in time.

### SUMMARY OF THE INVENTION

Accordingly, the primary object of the present invention is to provide a kettle temperature sensing device, which can detect the temperature of water in the kettle and display the temperature real time and thus the user can make tea or coffee with a preferred temperature control.

To achieve above objects, the present invention provides a kettle temperature sensing device which includes a kettle body capable of being placed upon a heating unit; a periphery of the kettle body having a mouth and a handle; a kettle cover covering upon an opening of the kettle body; a center of the kettle cover being installed with a holding head; and a detector installed on the holding head of the kettle cover; the detector having a temperature sensing element for measuring water temperature; and the detector having a display for displaying values of temperature. The water temperature in the kettle can be measured directly and display real time.

In use, the kettle body is placed upon the heating unit. The water in the kettle body will generate hot air which will pass through the via hole of the stud to the receiving space of the head to be sensed by the temperature sensing element. The water temperature in the kettle body can be measured directly by the temperature sensing rod. The measuring temperature is displayed upon the display unit. Thus the user can know the temperature of tea or coffee, etc.

The various objects and advantages of the present invention will be more readily understood from the following detailed description when read in conjunction with the appended drawing.

### BRIEF DESCRIPTION OF THE DRAWINGS

FIGS. 1 and 1A are a schematic perspective view showing the kettle temperature sensing device of the present invention.

FIG. 2 is an exploded perspective view of the kettle temperature sensing device of the present invention.

FIG. 3 is a partial schematic view about the kettle temperature sensing device of the present invention.

FIG. 4 is an exploded schematic view of the kettle temperature sensing device of FIG. 3.

FIGS. 5 to 8 are exploded perspective view about the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

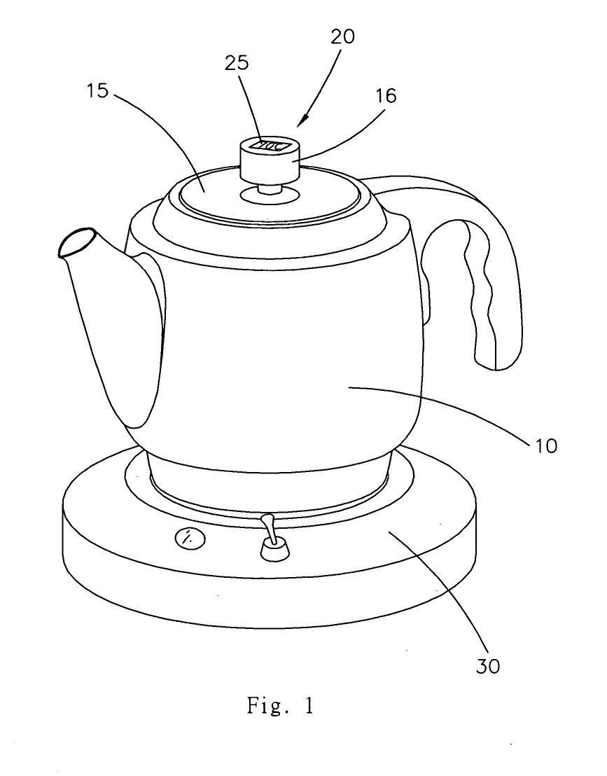

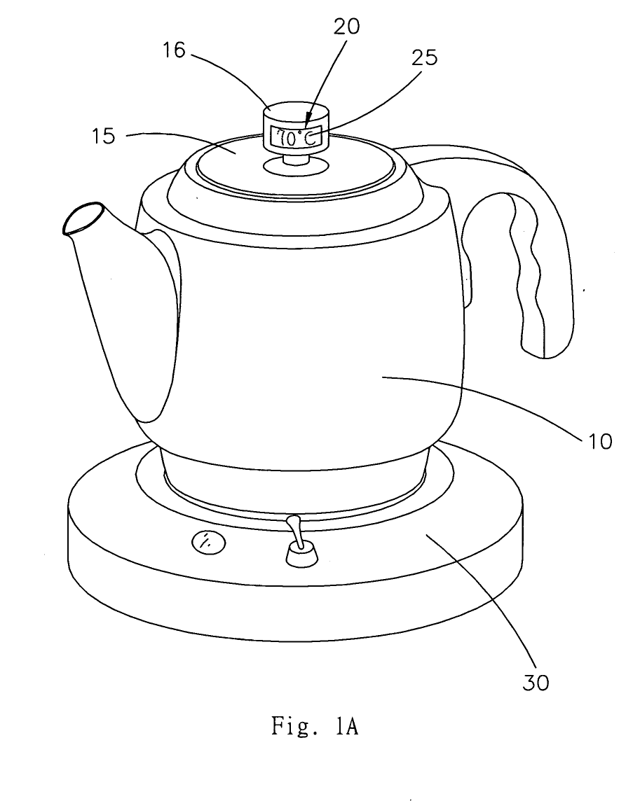

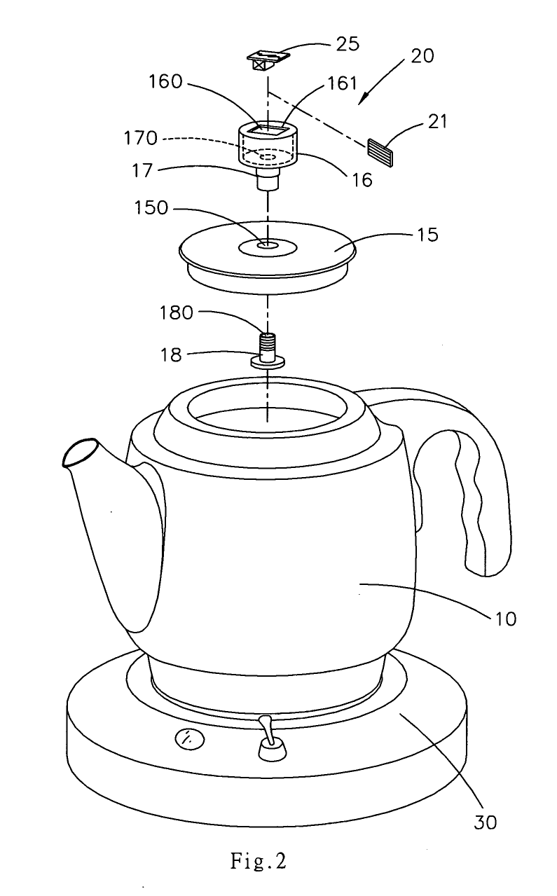

Referring to FIGS. 1 to 3, a kettle temperature sensing device of the present invention is illustrated. The present invention has the following elements.

A kettle body 10 can be placed upon a heating unit 30. The kettle body 10 is made of metals, ceramics, glass, etc. which is heat-tolerant. The kettle body 10 has an upward opening. A periphery of the kettle body 10 has a mouth and a handle.

A kettle cover 15 covers upon an opening of the kettle body 10. A center of the kettle cover 15 has a through hole 150. A center of the kettle cover 15 has a holding head 16. The head 16 has an extending tube 17 capable of passing through the through hole 150 of the kettle cover 15. The extending tube 17 can be locked by a stud 18 extending from an internal of the kettle cover 15. An internal of the head 16 is formed with a receiving space 160. A top or periphery of the head 16 is formed with a window 161 which is communicated to the receiving space 160. A center of the extending tube 17 is formed with a threaded hole 170. A center of the stud 18 is formed with a via hole 180 which is communicated with the receiving space 160.

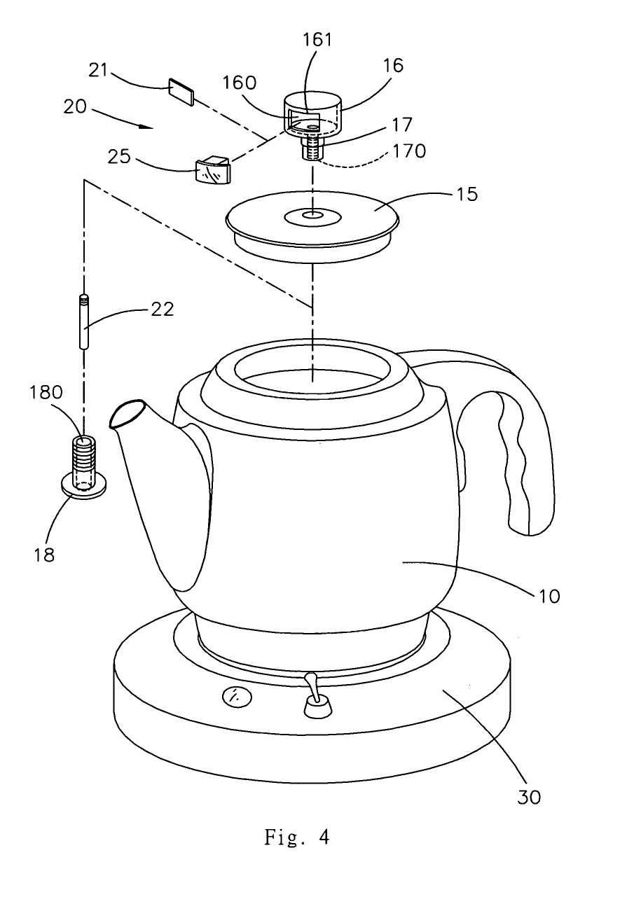

The detector 20 is installed on the kettle cover 15 and is received in the receiving space 160. The detector 20 has a temperature sensing element 21 which can be a temperature sensing integrated circuit or temperature sensing tube, or other elements capable of sensing temperature. Hot air passes through the via hole 180 of the stud 18 and then into the receiving space 160 of the head 16 for measuring the temperature. As shown in FIG. 4, the temperature sensing element 21 can be connected to a temperature sensing rod 22. The temperature sensing rod 22 extends downwards into the kettle body 10 for measuring the temperature of the water in the kettle body 10. The detector 20 has a display unit 25 which is located in the window 161 of the head 16. The window 161 may be at a top of the head 16 (referring to FIG. 1) or at a periphery of the head 16 (referring to FIG. 1A). The display unit 25 may be a liquid crystal display.

Thereby the water temperature in the kettle body 10 can be measured real time.

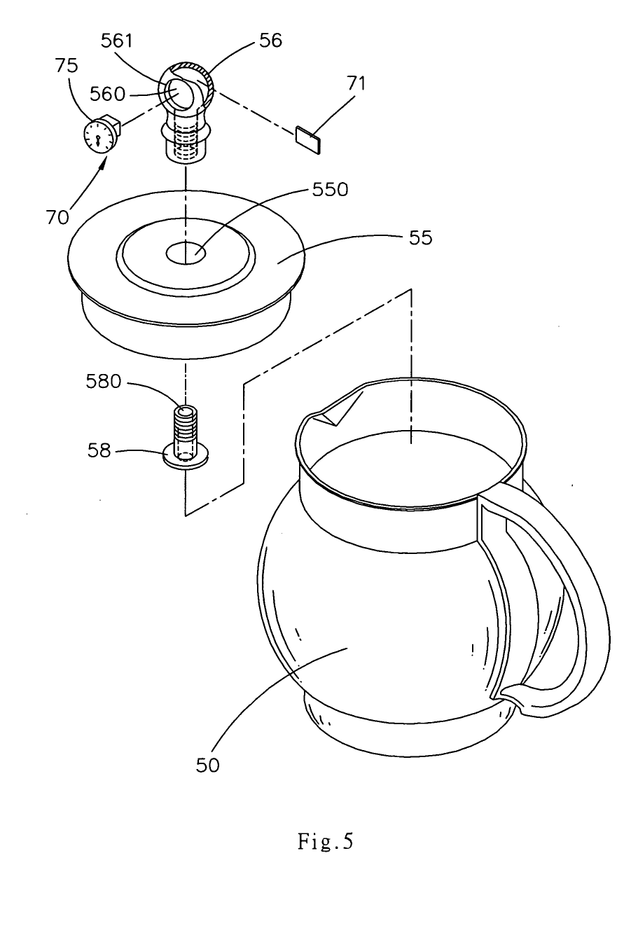

Referring to FIGS. 5 to 8, the second embodiment of the present invention is illustrated.

A kettle body 50 can be placed upon a heating unit 30. The kettle body 10 has an upward opening.

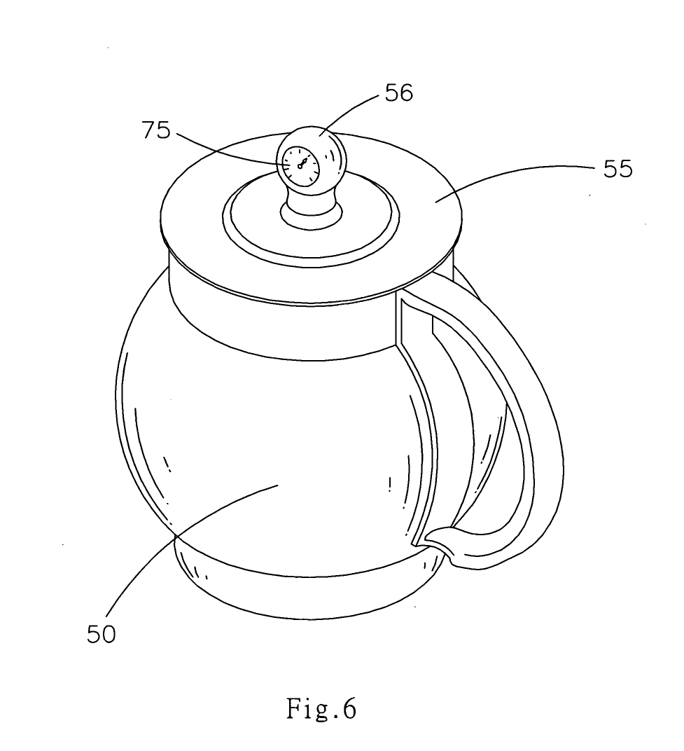

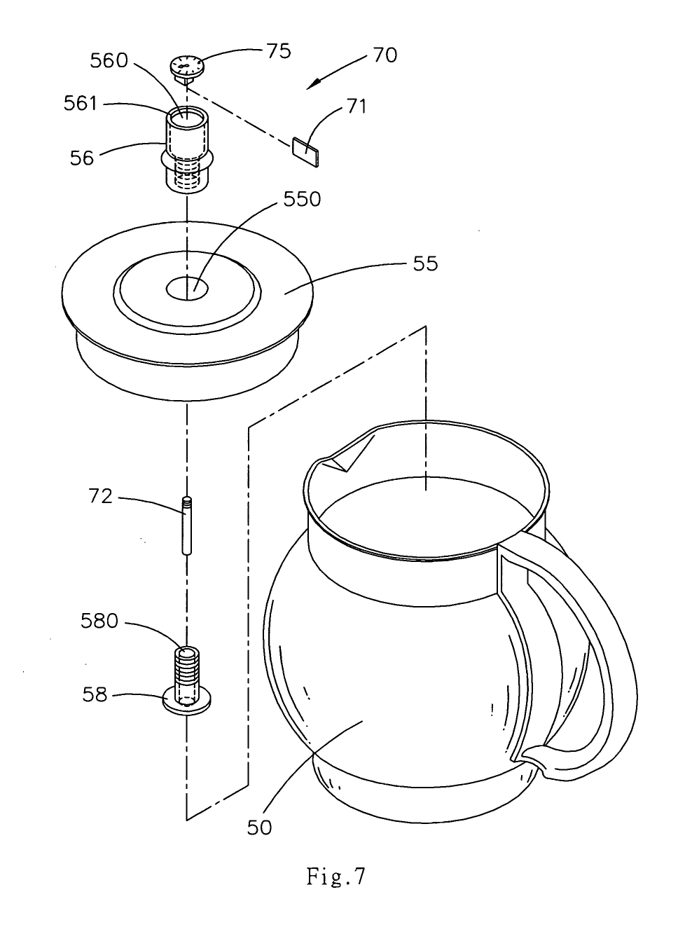

A kettle cover 55 covers upon an opening of the kettle body 10. A center of the kettle cover 55 has a through hole 550. A center of the kettle cover 15 has a holding head 56. The head 56 has an extending tube 57. The extending tube 57 can be locked by a stud 58. An internal of the head 56 is formed with a receiving space 560. A top (referring to FIG. 7) or periphery (referring to FIG. 6) of the head 56 is formed with a window 561 which is communicated to the receiving space 560. A center of the extending tube 57 is formed with a threaded hole 570. A center of the stud 58 is formed with a via hole 580 which is communicated with the receiving space 560.

The detector 70 is installed on the kettle cover 55 and is received in the receiving space 560. The detector 70 has a temperature sensing element 71 which can be a temperature sensing integrated circuit or temperature sensing tube, or other elements capable of sensing temperature. Hot air passes through the via hole 180 of the stud 58 and then into the receiving space 160 of the head 16 for measuring the temperature. As shown in FIG. 4, the temperature sensing element 21 can be connected to a temperature sensing rod 72. The temperature sensing rod 72 extends downwards into the kettle body 10 for measuring the temperature of the water in the kettle body 50. The detector 70 has a display unit 75 which is located in the window 561 of the head 56. The window 561 may be at a top of the head 16 (referring to FIG. 7) or at a periphery of the head 16 (referring to FIG. 6). The display unit 25 may be a liquid crystal display. The display unit 25 may be an indicator for showing the value of the temperature.

In the present invention, an alarm can be installed in the detector 20 or 70 for alerting the user as the temperature is over a set temperature.

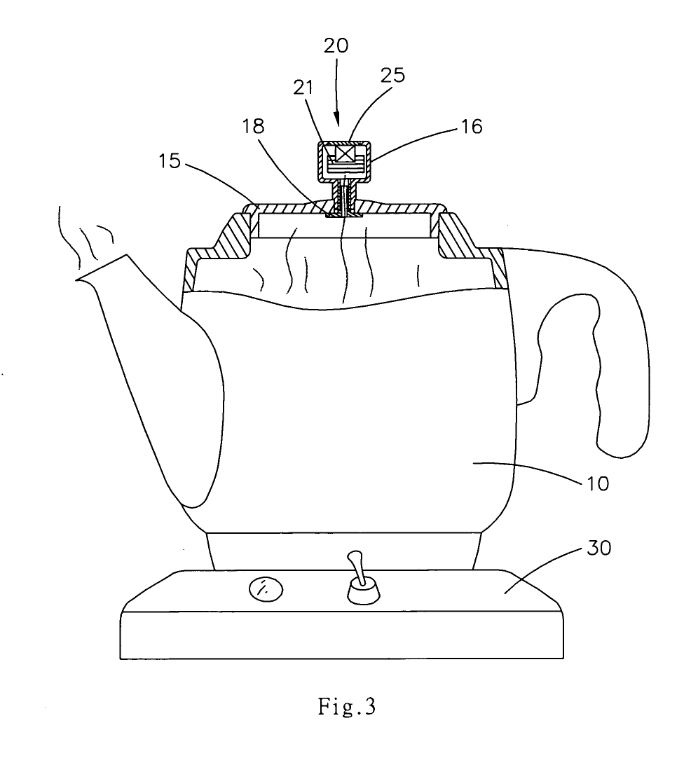

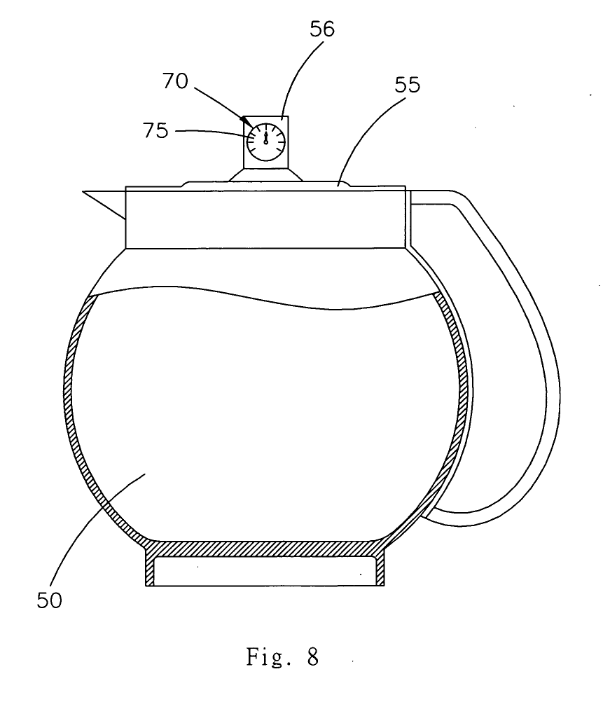

In use, as shown in FIGS. 3 and 8, the kettle body 10, 50 is placed upon the heating unit 30. The water in the kettle body will generate hot air which will pass through the via hole 180, 580 of the stud 18, 58 to the receiving space 160, 560 of the head 16, 56 to be sensed by the temperature sensing element 21, 71. The water temperature in the kettle body can be measured directly by the temperature sensing rod. The measuring temperature is displayed upon the display unit 25. Thus the user can know the temperature of tea or coffee, etc.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A kettle temperature sensing device comprising:
a kettle body capable of being placed upon a heating unit; a periphery of the kettle body having a mouth and a handle;
a kettle cover covering upon an opening of the kettle body; a center of-the kettle cover being installed with a holding head; and
a detector installed on the holding head of the kettle cover; the detector having a temperature sensing element for measuring water temperature; and the detector having a display for displaying values of temperature; and
wherein the water temperature in the kettle can be measured directly and display real time.

2. The kettle temperature sensing device as claimed in claim 1, wherein the kettle body is made of one of metals ceramics and glass which is heat-tolerant.

3. The kettle temperature sensing device as claimed in claim 1, wherein the head has an extending tube capable of passing through the through hole of the kettle cover; the extending tube is locked by a stud extending from an internal of the kettle cover; and a center of the extending tube is formed with a threaded hole.

4. The kettle temperature sensing device as claimed in claim 1, wherein a center of the kettle cover has a holding head; an internal of the head is formed with a receiving space for receiving the detector; a top or periphery of the head is formed with a window which is communicated to the receiving space; the detector has a display unit which is located in the window of the head.

5. The kettle temperature sensing device as claimed in claim 1, wherein the detector has a temperature sensing element which can be a temperature sensing integrated circuit or temperature sensing tube, or other elements capable of sensing temperature; a center of the stud is formed with a via hole which is communicated with the receiving space.

6. The kettle temperature sensing device as claimed in claim 1, wherein the temperature sensing element is connected to a temperature sensing rod; the temperature sensing rod extends downwards into the kettle body for measuring the temperature of the water in the kettle body.

7. The kettle temperature sensing device as claimed in claim 1, wherein the display unit is a liquid crystal display or an indicator.

8. The kettle temperature sensing device as claimed in claim 1, wherein an alarm device is installed in the detector for alerting the user as the temperature is over a set temperature.
